(19) United States
(12) Patent Application Publication
(10) Pub. No.: US 2009/0108618 A1
(43) Pub. Date: Apr. 30, 2009

(54) Instrument Panel Assembly of a Light-Weight Utility Vehicle

(75) Inventors: Bradley J. Hanson, North Augusta, SC (US); Donald S. Hanson, Evans, GA (US); Richard Krall, Augusta, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/965,779

(22) Filed: Dec. 28, 2007

Related U.S. Application Data
(60) Provisional application No. 60/983,684, filed on Oct. 30, 2007.

(51) Int. Cl. B62D 25/14

(52) U.S. Cl. 296/72; 296/70

(57) ABSTRACT

A multi-component instrument panel assembly for a light-weight utility vehicle is provided. The multi-component instrument panel assembly includes an instrument panel component including a first storage unit and a second storage unit. A first insert component is adapted to interconnect with a first side of the instrument panel component. A second insert component is adapted to interconnect with a second side of the instrument panel component. An eyebrow component is adapted to interconnect with the first insert component, the second insert component, and the instrument panel component. A beverage holder is adapted to interconnect with and outwardly extend from the instrument panel component and the eyebrow component.

### CROSS-REFERENCE TO RELATED APPLICATION

This application claims the benefit of U.S. Provisional Application No. 60/983,684, filed on Oct. 30, 2007. The disclosure of the above application is incorporated herein by reference.

### FIELD

The present disclosure relates to instrument panel assemblies of light-weight utility vehicles.

### BACKGROUND

The statements in this section merely provide background information related to the present disclosure and may not constitute prior art.

The use of motorized cars for transporting a golfer and golf bag on a golf course is well known in the art. Golf car designs have evolved to accommodate the needs of both golfers and golf car manufacturers. Golfers desire a golf car to meet their utility and convenience needs while at the same time to be aesthetically pleasing. Manufacturers aspire to reduce costs by creating durable golf cars with simple construction and a minimal number of parts.

Most golf cars or light-weight utility vehicles today include an instrument panel assembly of some sort. Typically, a conventional instrument panel assembly includes a single panel fabricated from a complex mold. Such instrument panel assemblies are molded to include any number of centrally located openings for electrical attachments, two storage units on both sides, and a beverage container. A number of visible screws connect such panels in an upright position to the front of a passenger compartment of the vehicle. When attached to the vehicle, the single panel provides little support to the overall structure of the vehicle. Further, the bottom walls or floors of the storage units of the conventional instrument panel lie horizontally, allowing for collection of water. At the same time the single panel has become less aesthetically pleasing.

### SUMMARY

Accordingly, a multi-component instrument panel assembly for a light-weight utility vehicle is provided. The multi-component instrument panel assembly includes an instrument panel component including a first storage unit and a second storage unit. A first insert component is adapted to interconnect with a first side of the instrument panel component. A second insert component is adapted to interconnect with a second side of the instrument panel component. An eyebrow component is adapted to interconnect with the first insert component, the second insert component, and the instrument panel component. A beverage holder is adapted to interconnect with and outwardly extend from the instrument panel component and the eyebrow component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings herein are for illustration purposes only and are not intended to limit the scope of the present disclosure in any way.

FIG. 1 is a side perspective view of a utility vehicle including an instrument panel assembly according to various embodiments.

FIG. 2A depicts an exploded view of the instrument panel assembly shown in FIG. 1 and arranged in accordance with various embodiments.

FIG. 2B depicts an assembled view of the instrument panel assembly shown in FIG. 1 and arranged in accordance with various embodiments.

FIG. 3 is a front view of an instrument panel of the instrument panel assembly in accordance with various embodiments.

FIG. 4A is a front perspective view of a first insert of the instrument panel assembly in accordance with various embodiments.

FIG. 4B is a front perspective view of a second insert of the instrument panel assembly in accordance with various embodiments.

FIG. 4C is an underside perspective view of the first insert of the instrument panel assembly in accordance with various embodiments.

FIG. 4D is an underside perspective view of the second insert of the instrument panel assembly in accordance with various embodiments.

FIG. 5A is a front view of an eyebrow of the instrument panel assembly in accordance with various embodiments.

FIG. 5B is a back view of an eyebrow of the instrument panel assembly in accordance with various embodiments.

FIG. 5C is a front view of a console of the eyebrow in accordance with various embodiments.

FIG. 5D is a front view of a removable panel of the eyebrow in accordance with various embodiments.

FIG. 5E is a back view of a removable panel of the eyebrow in accordance with various embodiments.

FIG. 6A is a side perspective view of a beverage holder of the instrument panel assembly in accordance with various embodiments.

FIG. 6B is top view of a beverage holder of the instrument panel assembly in accordance with various embodiments.

FIG. 7 is a cross-sectional view of the coupling of the instrument panel assembly to the cowl in accordance with various embodiments.

FIG. 8 illustrates the stack up of the assembled instrument panel assembly and cowl on rocker panels in accordance with various embodiments.

### DETAILED DESCRIPTION

The following description of the various embodiments is merely exemplary in nature and is in no way intended to limit the present disclosure, application, or uses. Throughout this specification, like reference numerals will be used to refer to like elements.

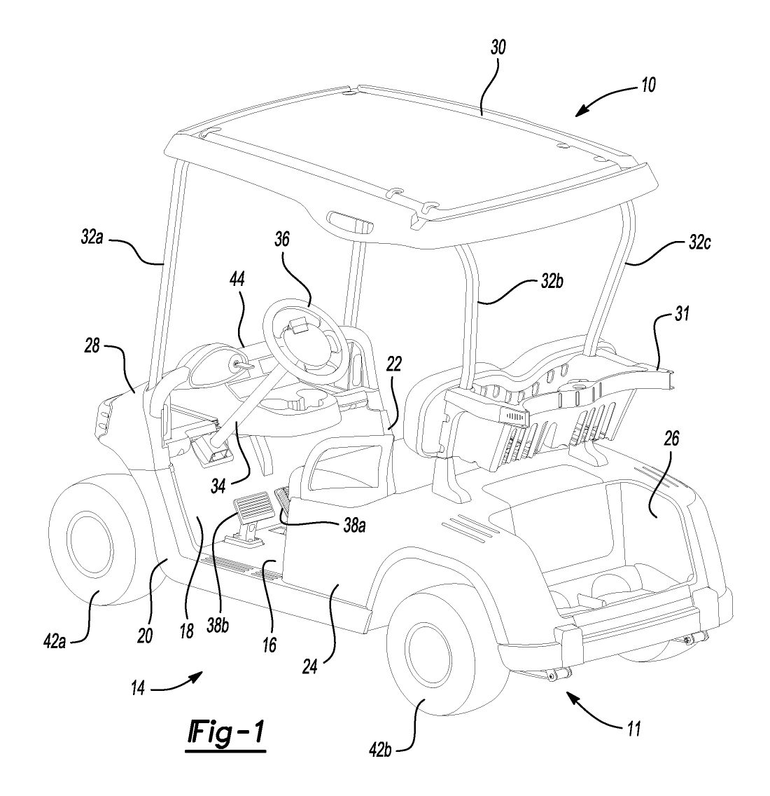

Referring now to FIG. 1, a utility vehicle is shown generally at 10. Utility vehicle 10 can include a plurality of conventional components. In various embodiments, utility vehicle 10 of FIG. 1 includes an instrument panel assembly 44 according to the present disclosure. As can be appreciated, light-weight utility vehicles such as a golf car or other light-weight utility vehicles including, but not limited to, maintenance vehicles, cargo vehicles, and shuttle vehicles may include various embodiments of instrument panel assembly 44 according to the present disclosure.

In various embodiments, a frame shown generally at 11 provides support and structure for utility vehicle 10. A body is mounted to frame 11 and is shown generally at 14. Body 14 includes a floorboard 16, a floor mat 18, rocker panels 20 and 22, a bench 24, a storage unit 26, a cowl 28, and a canopy 30. More specifically, floor mat 18 covers floorboard 16. Rocker panels 20 and 22 mount to either side of floorboard 16 and floor mat 18. Bench 24 is mounted to and located above floorboard 16. Bench 24 has two laterally spaced seats for at least two occupants, a driver and a passenger. Cowl 28 extends across the front of body 14. Storage unit 26 is located behind bench 24 and can be designed to accommodate at least two golf bags in an upright position. Canopy 30 can connect to front struts 32A and back struts 32B and 32C extending upwardly from the front and rear of body 14. A basket 31 can connect to back struts 32B and 32C.

A steering assembly includes a steering column 34 and a steering wheel 36. Steering column 34 extends upwardly from floorboard 16 of body 14. Steering column 34 is angled inwardly toward bench 24 adjacent to the driver seat. The steering wheel 36 is provided at the end of steering column 34. Driver controls 38A and 38B extend outwardly from floorboard 16. Driver controls 38A and 38B can be an accelerator pedal and a brake pedal respectively.

Beneath bench 24 of body 14 is a propulsion system (not shown). Propulsion system can be any known propulsion system in the art, including but not limited to, an electric motor and a gas engine. The propulsion system typically propels rear wheels 42B of utility vehicle 10 based on input provided from driver controls 38A and 38B. Electrical sensors and/or mechanical connections control the state of the propulsion system to direct operation of utility vehicle 10.

Connected to body 14 of utility vehicle 10 is an instrument panel assembly 44 according to various embodiments. Instrument panel assembly 44 enables the mounting of controls such as, but not limited to, an ignition switch for directing the state of the propulsion system and indicators such as, but not limited to, a speed gauge for displaying the status of the propulsion system. Instrument panel assembly 44 further provides storage, such as for items typical to the game of golf, for example tools, golf balls, tees, beverages, cell phones, sunglasses, lotions, and clothing in accordance with various embodiments. When connected to body 14, instrument panel assembly 44 also provides support for the overall structure of utility vehicle 10, as will be discussed further below.

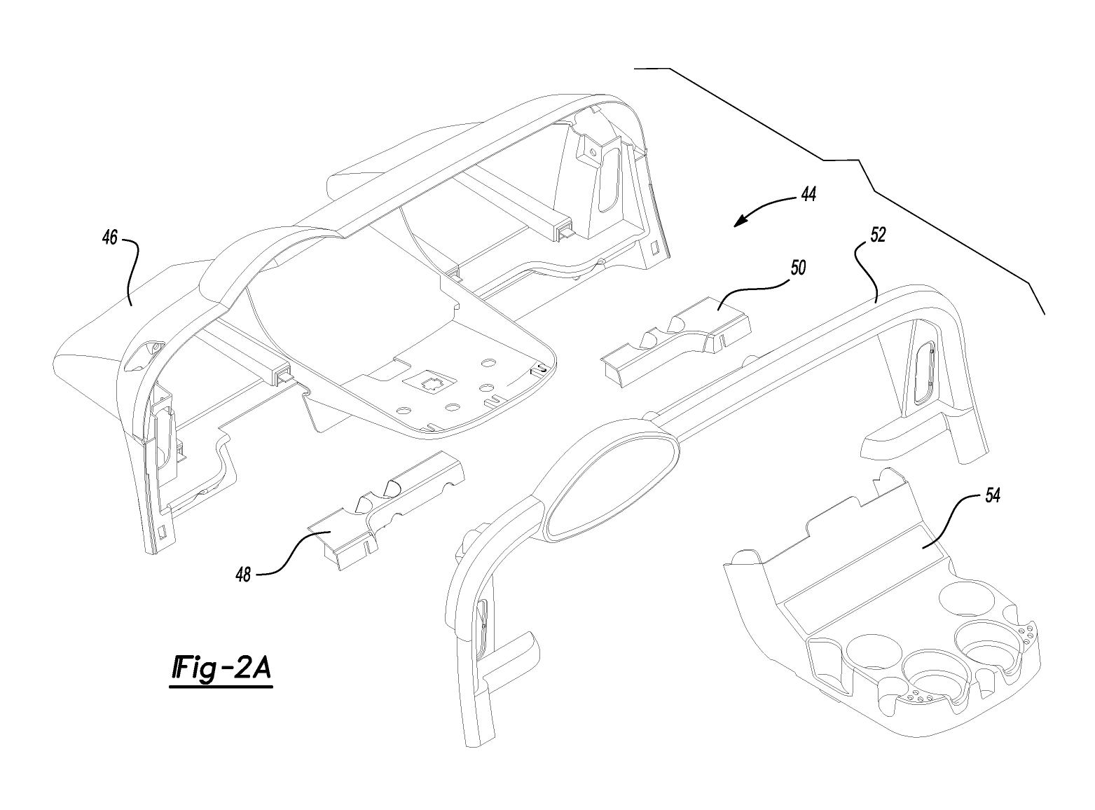

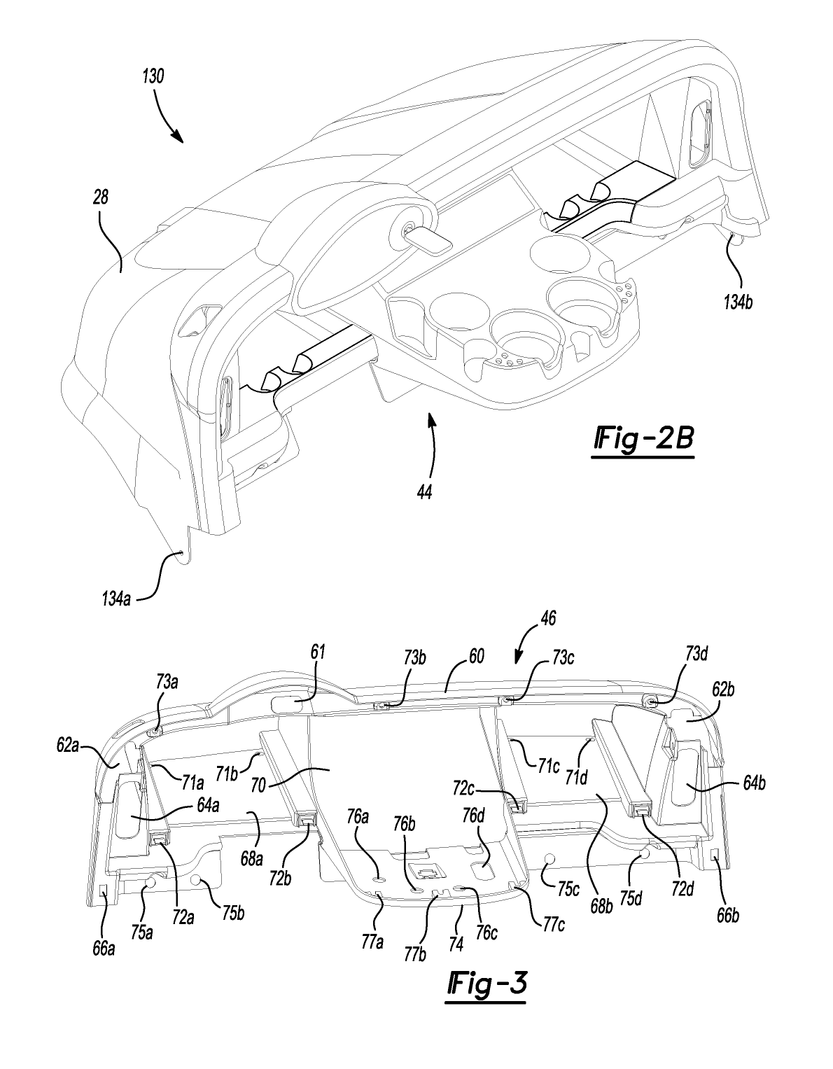

Referring now to FIG. 2A, FIG. 2A depicts various components of instrument panel assembly 44 according to various embodiments. The components can be individually fabricated and later assembled to form instrument panel assembly 44. The components include an instrument panel 46, a first insert 48, a second insert 50, an eyebrow 52, and a beverage holder 54. First and second inserts 48 and 50 are connectable to instrument panel 46 to provide mounting points for eyebrow 52. Eyebrow 52 is connectable to instrument panel 46 and first and second inserts 48 and 50. Eyebrow 52 provides an aesthetically pleasing covering for instrument panel 46. Beverage holder 54 is connectable to instrument panel 46 to enable the user of utility vehicle 10 to store beverages and other items of various sizes. Various suitable fasteners can be utilized to interconnect the individual components. In various embodiments, connectors and receptors, as will be discussed further below, allow for the interconnection of the individual components into instrument panel assembly 44. FIG. 2B illustrates an assembled instrument panel assembly 44.

Referring now to FIG. 3, FIG. 3 depicts a front view of instrument panel 46. Instrument panel 46 is individually molded to include a shell 60, storage units 68A and 68B, a horizontal surface 74, and one or more snap connectors and receptors. The instrument panel 46 extends the width of body 14, to maximize the size of storage units 68A and 68B and to also provide additional stability to frame 11 of the utility vehicle 10 as shown in FIG. 1. Shell 60 is u-shaped and extends across the top portion of instrument panel 46. A portion of shell 60 is curved to allow for the interconnection with eyebrow 52 of FIG. 2A. Below the curvature, shell 60 includes an opening 61 to allow for the reception of a wiring harness from the propulsion system. Shell 60 includes openings 62A and 62B on either side of shell 60 that are shaped to allow front struts 32A of FIG. 1 to pass through openings 62A and 62B. Shell 60 further includes openings 64A and 64B on either side of shell 60 that face horizontally and are shaped to allow convenient access to front struts 32A of FIG. 1.

Storage units 68A and 68B are formed and positioned within instrument panel 46 to create a center opening 70. Bottom floors of storage units 68A and 68B are angled with respect to the horizontal to facilitate drainage and cleaning of instrument panel 46. Drainage holes 71A-71D provide for drainage of instrument panel 46. Horizontal surface 74 extends between and partially frontward from storage units 68A and 68B. Horizontal surface 74 includes one or more drainage ports 76A-76D to facilitate drainage of liquids and debris, such as water, beverages, dust, dirt, etc., from the horizontal surface 74.

To facilitate the interconnection with the other components of the instrument panel assembly 44, one or more receptors 66A and 66B are located on the lower end of shell 60 and one or more snap connectors 72A-72D are located on either side of each storage unit 68A and 68B. As will be discussed in more detail below, apertures 73A-73D of shell 60 allow for interconnection of instrument panel 46 with eyebrow 52 and cowl 28 of FIGS. 2A and 2B. Apertures 75A-75D of shell 60 allow for interconnection of instrument panel 46 with floorboard 16 of FIG. 1. Apertures 77A-77C of horizontal surface 74 allow for interconnection of instrument panel 46 with beverage holder 54 of FIG. 2A.

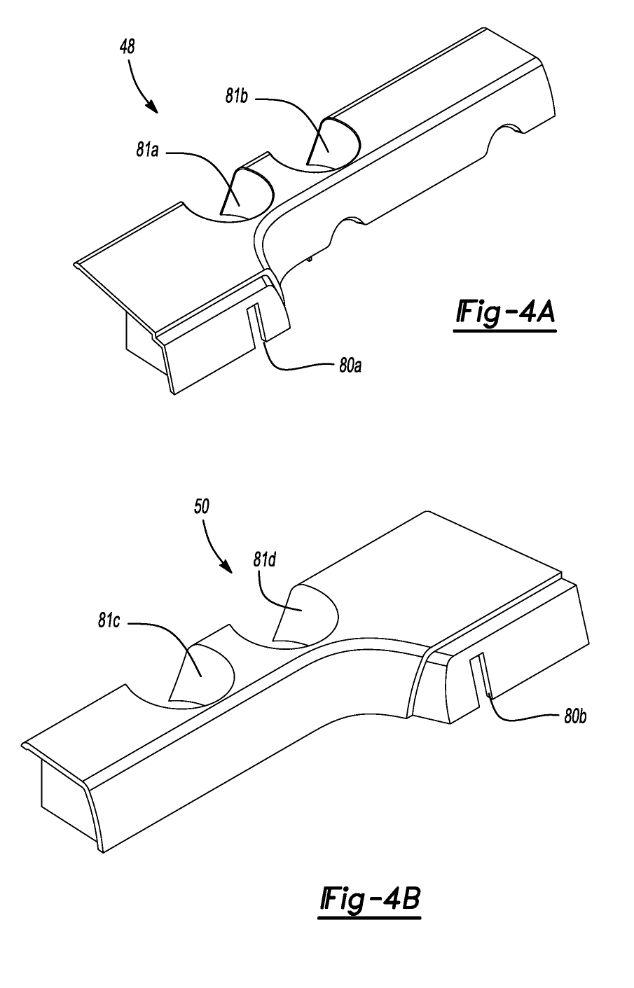

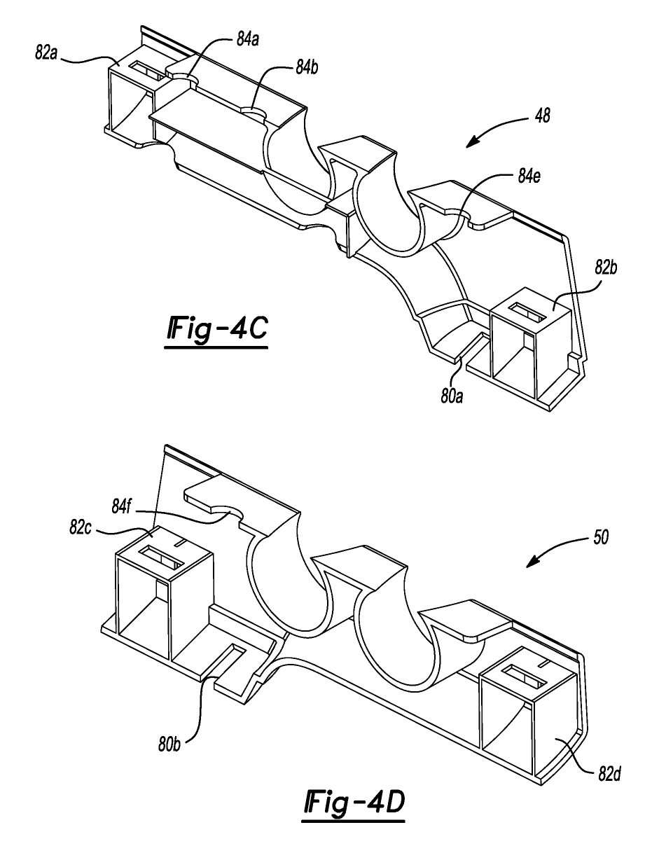

FIGS. 4A and 4B depict front perspective views of first insert 48 and second insert 50 respectively shown in FIGS. 2A and 2B. First and second inserts 48 and 50 include receptors 80A and 80B that mate with corresponding snap connectors of eyebrow 52 (as will be discussed in more detail below). First and second inserts 48 and 50 can optionally include ball holders 81A-81D that store golf balls when assembled to instrument panel 46 of FIG. 3.

As shown in the underside views of first and second inserts 48 and 50 in respective FIGS. 4C and 4D, first and second inserts 48 and 50 include at least two receptors 82A-82D for assembly to snap connectors 72A-72D of instrument panel 46 in FIG. 3. First and second inserts 48 and 50 include grooves 84A-84H. When assembled, grooves 84A-84B and 84E-84F allow drainage of water and debris to flow from storage units 68A and 68B of FIG. 3 through the open area of grooves 84A-84B and 84E-84F.

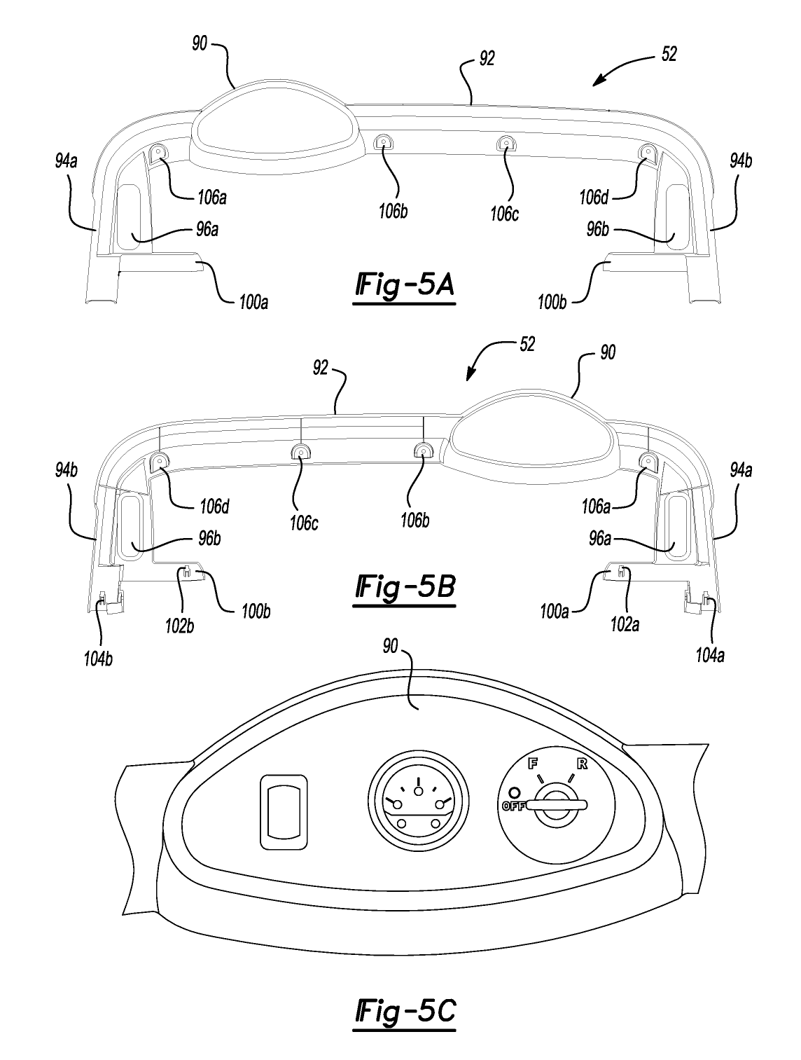

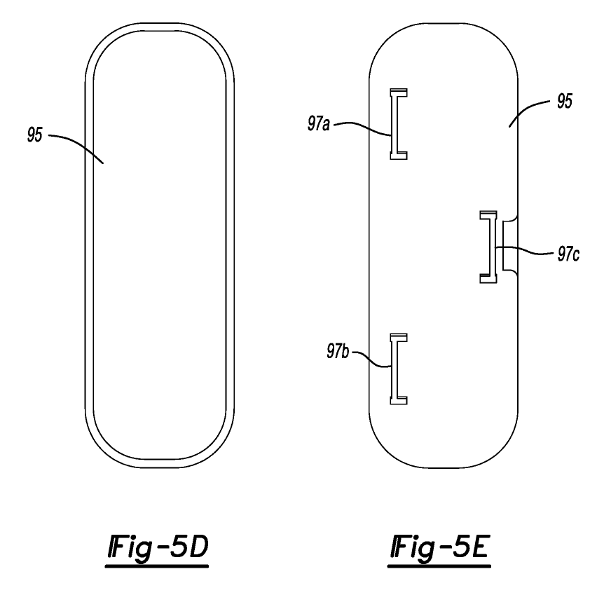

FIG. 5A depicts a front view of eyebrow 52. Eyebrow 52 includes u-shaped instrument panel trim 92 and a console 90. The generally oval shaped console 90 faces generally outward from instrument panel trim 92. Console 90 can be located in a position conveniently viewable to a driver of utility vehicle 10. In some embodiments, console 90 is located generally toward a first side of eyebrow 52, for example toward a left side. In various other embodiments, console 90 can be located generally toward a second side of eyebrow 52, for example toward a right side.

As shown in FIG. 5C, console 90 is optionally configured to accommodate switches and gauges. Non-limiting examples of switches can include on/off switches for lights or other accessories or a reverse switch. Non-limiting examples of gauges can include a speed gauge, a gas gauge, a battery voltage gauge, or an ammeter. The wiring harness, as previously discussed, extending from the propulsion system of utility vehicle 10 can be connected to switches and gauges through the back of console 90 and opening 61 of instrument panel 46.

Eyebrow 52 of FIG. 5A also includes vertically extending side sections 94A and 94B. Removable panels 95 of FIGS. 5D and 5E can be assembled to side sections 94A and 94B over horizontally facing openings 96A and 96B. The back side of removable panels 95, as shown in FIG. 5E, include at least three elevated snap connectors 97A-97C capable of assembling removable panels 95 to eyebrow 52. Openings 96A and 96B provide access to front struts 32A of FIG. 1 when removable panels 95 are removed.

FIG. 5B depicts a back view of eyebrow 52. Eyebrow 52 includes connector supports 100A and 100B that extend substantially horizontally from side sections 94A and 94B. Snap connectors 102A and 102B extend from connector supports 100A and 100B for assembling eyebrow 52 to first and second inserts 48 and 50 shown in FIGS. 4A and 4B via receptors 80A and 80B. Snap connectors 104A and 104B extend from the lower portion of side sections 94A and 94B for assembling eyebrow 52 to instrument panel 46 in FIG. 3 via receptors 66A and 66B. Apertures 106A-106D in the lower portion of trim 92 allow for interconnection of the eyebrow 52 with instrument panel 46 and cowl 28 of FIG. 2B, as will be discussed further below.

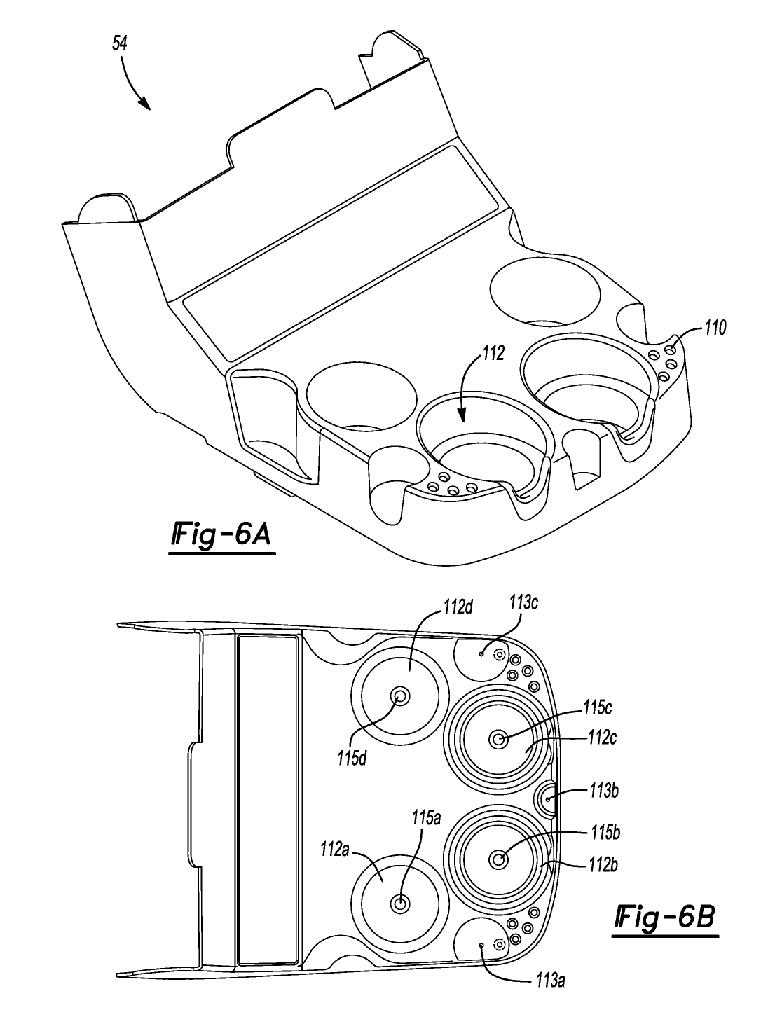

Referring now to FIGS. 6A and 6B, beverage holder 54, assembles to the center of instrument panel 46 and eyebrow 52. In particular, apertures 113A-113C of beverage holder 54 allow for the interconnection of beverage holder 54 with horizontal surface 74 of instrument panel 46 of FIG. 3 via apertures 77A-77C and fasteners. Non-limiting examples of fasteners can include bolts and screws. Beverage holder 54 includes wells 112A-112D for the purpose of containing beverages of assorted sizes. Bottom surfaces of wells 112-112D include drainage holes 115A-115D to allow liquids and debris to flow through. When assembled, excess liquid flows through drainage holes 115A-115D of beverage holder 54 and drainage ports 76A-76D of horizontal surface 74 of instrument panel 46 of FIG. 3 and exit to the mat 18 of FIG. 1. In various embodiments, beverage holder 54 can optionally include apertures shown generally at 110 for the purpose of storing golf tees.

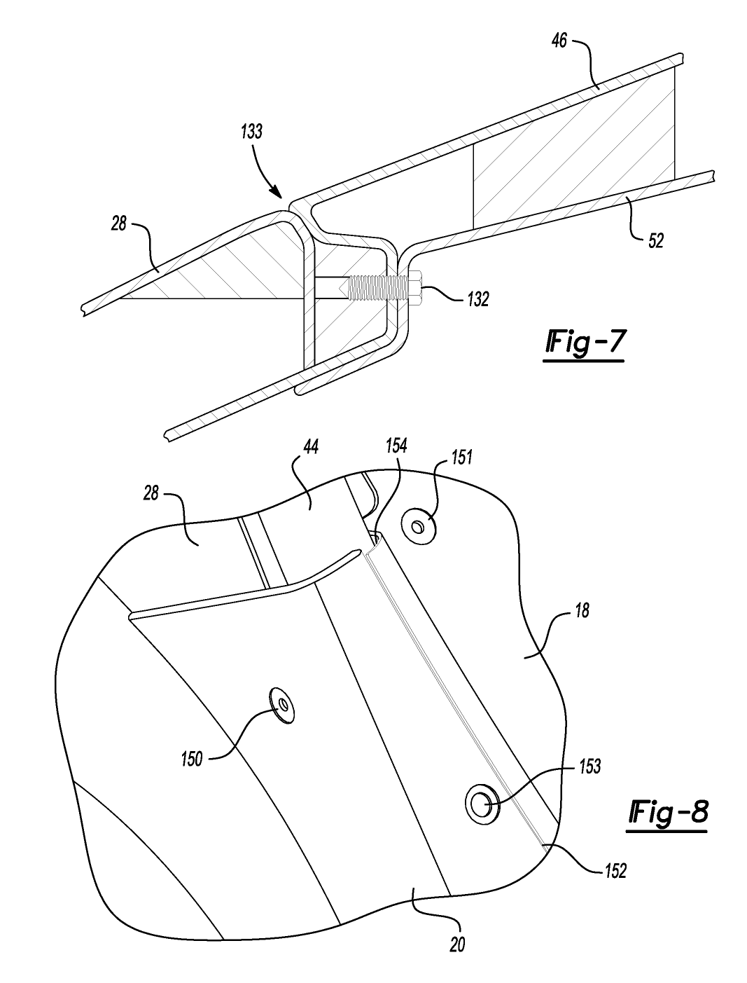

Referring back to FIG. 2B, FIG. 2B depicts the instrument panel assembly 44 assembled to cowl 28 generally at 130. Instrument panel assembly 44 connects to cowl 28 by fasteners 132. Non-limiting examples of fasteners 132 can include bolts and screws. FIG. 7 depicts a cross-sectional view of instrument panel assembly 44 assembled to cowl 28. When apertures are aligned, fasteners 132 extend through apertures in eyebrow 52, instrument panel 46, and cowl 28. When fastened, fasteners 132 secure eyebrow 52 to instrument panel 46, and cowl 28. Fasteners 132 fastened just below the trim 92 of eyebrow 52 are hidden from a driver's view, but still accessible. When assembled, instrument panel assembly edge overlaps the cowl edge at 133 to prevent fluids from seeping near fasteners 132.

Referring to FIG. 8, FIG. 8 depicts a first rocker panel 20 assembled to a first side of utility vehicle 10, also shown in FIG. 1. A second rocker panel 22 assembles similarly to a second side of utility vehicle 10. An aperture 134A of cowl 28 shown in FIG. 2B aligns with an aperture 150 of rocker panel 20. When apertures are aligned, a fastener extends through aperture 150 in rocker panel 20 and aperture 134A in cowl 28 to secure cowl 28 to rocker panel 20.

Fasteners can be used to secure the lower end of instrument panel assembly 44 to floorboard 16. For example, aperture 151 of floor mat 18 and floorboard 16 allow instrument panel assembly 44 to be secured to floorboard 16. Fasteners pass through aperture 151 of floor mat 18, floorboard 16, and instrument panel assembly 44. Similarly, fasteners can be used to secure rocker panel 20 to floor mat 18 and floorboard 16. For example, aperture 153 of rocker panel 20, floor mat 18, and floorboard 16 allow rocker panel 20 to be secured to floor mat 18 and floorboard 16. Fasteners pass through aperture 153 of rocker panel 20, floor mat 18, and floorboard 16. To provide support to instrument panel assembly 44, rocker panel 20 is designed to overlap floor mat 18 at 152. The overlap 152 is structured and positioned to provide support to instrument panel assembly 44 at 154.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A multi-component instrument panel assembly for a light-weight utility vehicle, comprising:
an instrument panel component including a first storage unit and a second storage unit;
a first insert component adapted to interconnect with a first side of the instrument panel component;
a second insert component adapted to interconnect with a second side of the instrument panel component;
an eyebrow component adapted to interconnect with the first insert component, the second insert component, and the instrument panel component; and
a beverage holder adapted to interconnect with and outwardly extend from the instrument panel component and the eyebrow component.

2. The instrument panel assembly of claim 1, wherein the eyebrow component comprises:
trim adapted to interconnect with the instrument panel component and extend horizontally across the instrument panel component;
a console outwardly extending from the trim; and
first and second side sections extending vertically from the trim, wherein the first and second side sections each include a removable panel.

3. The instrument panel assembly of claim 1, wherein a bottom floor of the first storage unit and a bottom floor of the second storage unit is angled to facilitate drainage.

4. The instrument panel assembly of claim 1, wherein the first and second insert components include grooves to facilitate drainage.

5. The instrument panel assembly of claim 1 further comprising receptors and snap connectors and wherein the components of the instrument panel assembly are interconnected via the receptors and the snap connectors.

6. The instrument panel assembly of claim 1, wherein the instrument panel includes at least two vertically facing openings to allow for the passage of front struts of the golf car.

7. A method of assembling an instrument panel assembly, comprising:
connecting a first insert to a first surface of a instrument panel;
connecting a second insert to a second surface of the instrument panel;
connecting an eyebrow to a front surface of the first insert;
connecting the eyebrow to a front surface of the second insert;
connecting the eyebrow to a first lower end and a second lower end of the instrument panel; and
securing a beverage holder to a center of the instrument panel.

8. The method of claim 7 further comprising coupling the assembled instrument panel assembly to a cowl using fasteners.

9. The method of claim 7, wherein the steps of connecting are performed by snapping snap connectors to receptors.

10. The method of claim 8 further comprising coupling the assembled instrument panel assembly and the cowl to a floorboard of a golf car.

11. The method of claim 10 further comprising coupling the assembled instrument panel assembly and the cowl to rocker panels of a golf car.

12. The method of claim 11 further comprising coupling a floor mat under rocker panels.

13. A light-weight utility vehicle, comprising:
a frame;
a body that defines a passenger compartment of the utility vehicle that mounts to the frame, wherein the body includes a forward portion and a rearward portion; and
an instrument panel assembly mounted to the forward portion of the body and wherein the instrument panel assembly includes a plurality of components that are individually fabricated and thereafter interconnected.

14. The light-weight utility vehicle of claim 13, wherein the plurality of components of the instrument panel assembly include:
an instrument panel component including a first storage unit and a second storage unit;
a first insert component adapted to interconnect with a first side of the instrument panel component;
a second insert component adapted to interconnect with a second side of the instrument panel component;
an eyebrow component adapted to interconnect with the first insert component, the second insert component, and the instrument panel component; and
a beverage holder adapted to interconnect with and outwardly extend from the instrument panel component and the eyebrow component.

15. The light-weight utility vehicle of claim 13 further comprising a plurality of struts mounted to and extending vertically from the frame wherein the instrument panel assembly includes openings that face vertical and that are shaped to allow forward struts of the plurality of struts to pass through the openings.

16. The light-weight utility vehicle of claim 15, wherein the instrument panel assembly includes first and second panels that are removable and wherein when the panels are removed openings that face horizontal are exposed to allow access to forward struts at a location where the forward struts mount to the frame.

17. The light-weight utility vehicle of claim 13, wherein the body includes:
a floorboard;
a floor mat covering the floorboard; and
first and second rocker panels that fasten to first and second sides of the floorboard and the floor mat wherein the first and second rocker panels overlap the floorboard and the floor mat.

18. The light-weight utility vehicle of claim 17 further comprising a cowl coupled to the instrument panel assembly, wherein the cowl includes apertures that align with apertures of the instrument panel assembly, and wherein fasteners extend through the apertures to couple the cowl to the instrument panel assembly.

19. The light-weight utility vehicle of claim 17, wherein apertures in the instrument panel assembly align with apertures in the frame, apertures in the floor mat and apertures in the floorboard, and wherein fasteners extend through the apertures in the instrument panel assembly, apertures in the floor mat, apertures in the floorboard and apertures in the frame to couple the instrument panel assembly to the frame.

20. The light-weight utility vehicle of claim 18, wherein the apertures in the cowl align with aperture in the first and second rocker panels and wherein the fasteners extend through the apertures in the cowl and apertures in the first and the second rocker panels to couple the cowl to the first and the second rocker panels.

21. The light-weight utility vehicle of claim 13, wherein the first and the second rocker panels provide subjacent support to side sections of the instrument panel assembly.
